(19) United States
(12) Patent Application Publication
(10) Pub. No.: US 2008/0011168 A1
(43) Pub. Date: Jan. 17, 2008

(54) Printing apparatus and printing method for the same

(75) Inventors: Hiroyuki Yamauchi, Nagoya-shi (JP); Tomoyoshi Yabe, Nagoya-shi (JP)

Correspondence Address: KRATZ, QUINTOS & HANSON, LLP, 1420 K Street, N.W., Suite 400, WASHINGTON, DC, 20005, US

(73) Assignee: NICHIHA CO., LTD., Nagoya-shi (JP)

(21) Appl. No.: 11/600,281

(22) Filed: Nov. 16, 2006

Related U.S. Application Data
(60) Provisional application No. 60/762,902, filed on Jan. 30, 2006.

(51) Int. Cl. B41F 17/00

(52) U.S. Cl. 101/35

(57) ABSTRACT

Horizontal joint portions of abutting building boards are constructed in a manner to look straight-line in an external appearance when constructed even in a case that the building board has a dimension error. A printing apparatus for printing a building board of a shiplap joint system composed of a design surface having a horizontal joint portion formed along a longitudinal direction of the building board and an upper and lower shiplap portions formed at an end portion of the building board includes a fixed printing head having a plurality of nozzles for performing printing operation by means of emitting a jet of ink toward the design surface of the building board, in which the printing head performs printing operation along a printing line spaced apart from an edge of the upper shiplap portion or the lower shiplap portion at a constant distance when performing the printing operation for the horizontal joint portion.

### BACKGROUND OF THE INVENTION

1. Field of the Invention

The present invention relates to a printing apparatus and a printing method for the same, and more particularly to a printing apparatus and a printing method for a building board.

2. Description of the Related Art

An example of a building board having an uneven surface with a design is partially shown in FIG. 6. The building board that is used as an external wall board has an entire shape of a long rectangular board, and the building board having a design, in which a number of rectangular convex portions are arranged in an orderly fashion in vertical and horizontal directions, such as a brick work, tiling, or the like is often used. A number of flat surfaces 101 of convex portions, and horizontal joint portions 102 and vertical joint portions 103 that continue around a periphery of the convex portions in a groove condition are formed on the design surface of the building board as shown in FIG. 6 in concrete form.

A building board 100 shown in FIG. 7 is a board of a four-direction shiplap joint system, and is composed of a lower shiplap portion 110 that is continuously formed in an L-shaped manner in a condition of protruding from a design surface from an upper edge portion serving as a longer edge to a right edge portion serving as a shorter edge, and an upper shiplap portion 120 that is continuously formed in an L-shaped manner from a lower edge portion serving as a longer edge of the design surface of the building board to a left edge portion serving as a shorter edge. The lower shiplap portion 110 is constructed to be a step portion formed in the front side of the building board 100, and the upper shiplap portion 120 is constructed to be a step portion formed at the backside of the building board 100. Further, by constructing the upper shiplap portion and the lower shiplap portion of each of the building boards abuttingly disposed from right to left or up and down in an overlapped manner, a so-called shiplap jointing is formed.

In many cases, the above-described horizontal joint portion 102 and the vertical joint portion 103, and a number of flat surfaces 101 of convex portions are coated with different colors (two-tone color). As for a general coating method, an entire surface of the building board (including the lower shiplap portion 110 protruding from the design surface) is coated with a color of the joint portion (middle coating) by means of a spray coating, and thereafter, the flat surface 101 of the convex portion is coated with a color (final coating) different from that of the middle coating by means of a coating using a roll coater. A spatter coating by means of a spray method, an ink jet coating, or the like is sometimes performed for the flat surface 101 of the convex portion as a decorative coating using a coating material of further different color as well.

A building board of ceramic series (cement board) is manufactured by means of following wet process, for example. A half-finished product of an integral cement board called large board that is composed of a plurality of sheets of board is formed first. In concrete terms, cement slurry having fluidity is formed and an emboss design is press-formed on the surface thereof, and cut out into a dimension of the large board. Then, the half-finished products of the large board are hardened by heat treating in a condition of being stacked in multiple steps via spacers, and a number of sheets of the large board are obtained by means of further performing autoclave curing. The thus obtained large board is cut out and decoupled into a rectangular shaped cement board at a predetermined dimension. In the cutting out process described above, an error on vertical and horizontal dimensions conceivably occurs due to nature of a hardened element of cement. In addition, since the lower shiplap portion 110 and the upper shiplap portion 120 that are formed at four edge portions of the decoupled cement board are formed by means of cutting work, a dimension error at a width of the shiplap portion cannot be prevented from occurring. However, as for the design surface having the flat surface 101 of the convex portion, since the same is formed by means of emboss molding in a manufacturing process for the cement board, the error hardly occurs on the dimension of each of the portions.

Next, a deviation at a horizontal joint portion occurring in a case of structuring an external wall portion of a building by means of building board will be explained referring to FIGS. 8A through 8C. FIG. 8A is a perspective view showing an external appearance of a construction of the left and right joint portions of building boards, 100a and 100b, that are arranged at the left and right. The left and right building boards, 100a and 100b, are disposed opposing side end faces of both in front of a vertical furring strip 82 that is fixed to a front face of a building frame of a column (not shown) or the like via a hat joiner 84. Each of the building boards, 100a and 100b, is fixed to the vertical furring strip 82 with a screw 81 by means of a fastening member 80 that is engaged on the lower shiplap portion 110 formed at an upper edge portion. Further, as for a gap portion between both of the building boards, 100a and 100b, formed by the hat joiner 84, a sealing material 83 is filled up for rain guard.

FIG. 8B is a cross-sectional view showing a structure of the construction of upper and lower joint portions of the building boards, 100a and 100c, that are arranged above and below. As shown in FIG. 8B, the fastening member 80 is fixed to the vertical furring strip 82 with the screw 81, in a condition for a lower shiplap portion 110c of the building board 100c arranged at a lower side to be engaged on a lower board engaging portion 803 of the fastening member 80. Further, an upper shiplap portion 120a of a building board 100a arranged at an upper side is engaged on an upper board engaging portion 802 of the fastening member 80, and weight of the building board 100a is supported by means of a supporting portion 804 of the fastening member 80.

FIG. 8C is a front view showing a condition of construction of the abutting building boards, 100a and 100b, arranged at the left and right sides. As shown in the drawing, the building boards are respectively arranged at the right and left sides of a joint line O-O. In a fastening process for the building board, in principle, the building board at the left side is fastened first, and in conformity therewith, the building board at the right side is fastened next. Further, the building board at the lower side is fastened first, and in conformity therewith, the building board at the upper side is fastened next. In the present example, a case in which a dimension accuracy of the building board is controlled for latitude within ±1 mm, and a width in a direction of a shorter edge side (vertical direction) of the building board 100a fastened to the left side is assumed to be smaller than a standard dimension by 1 mm, and a width in a direction of a shorter edge side (vertical direction) of the building board 100b fastened to the right side is assumed to be larger than the standard dimension by 1 mm. Further, the two building boards, 100a and 100b, are assumed to be fastened in a manner for both of lower ends of upper shiplap portions, 120a and 120b, to be arranged on the same line.

In this case, an upper edge of the lower shiplap portion 110a of the building board 100a at the left side becomes lower than that of the lower shiplap portion 110b of the building board 100b at the right side by 2 mm. Namely, the upper edges of the two building boards, 100a and 100b, deviate each other by 2 mm. In association with the above, two horizontal joint portions, 102a and 102b, are not connected to look straight-line, and are deviated from each other by 2 mm in a vertical direction at a position of the joint line O-O. Therefore, a countermeasure is currently taken, in which the position where the building boards are fastened is adjusted vertically in an attempt to hide the deviation, though not sufficiently and the adjusting work is troublesome.

For background information on an ink-jet printer used in the printing field, a full color printing can be performed using inks of four colors of C, M, Y, and K (cyan, magenta, yellow, and black). In addition, a side of a printing head is moved in a reciprocating motion in a direction orthogonal to a paper feeding direction in a general case. A printer of this type is called serial-type printer. In contrast, in recent years, in the field of the ink-jet printer, a printer of a type (called line-type printer), in which the side of the printing head is fixed and a side of a paper is caused to travel in a constant direction being directed to the printing head, is proposed.

For example, a line-type printer is proposed in Japanese Unexamined Patent Application Publication Nos. 3-13347, 4-99688, 2000-318188, 2000-289233, and the like. Consequently, a surface of the building board is assumed to be printed by means of printing apparatuses of such a fixed printing head type.

However, following aspects need to be considered for printing the building board of the ceramic series. (1) A square measure to be printed is large. For example, a building board having a size of a dimension of 455 mm in a vertical direction and a dimension of 1818 mm in a horizontal direction is used. (2) Many of building boards have an uneven design surface to be printed. (3) An object to be printed is a cement board, i.e., a heavy load. (4) In view of productivity, a high speed printing is required. For example, a travel speed of the cement board is required to be realized in an extent from 40 to 60 meter/min.

The present applicant has disclosed an ink-jet coating method to be a basic coating method for the building board of the ceramic series in Japanese Patent No. 3115136. Further, a technology for expressing a graded color design using the ink-jet coating method has been also disclosed in Japanese Patent No. 2784529. However, although either of the methods described in the Japanese Patents above has a processing configuration of ink-jet, the same is not beyond the coating technology. In other words, since the methods use a coating material that is previously toned, a full-color printed image cannot of course be expressed.

As described above, in the building board of the ceramic series (cement series), occurrence of a dimension error caused by a manufacturing method thereof cannot be avoided. In concrete terms, the error appears as a dimension error of the upper shiplap portion or the lower shiplap portion. Consequently, when a number of sheets of the building boards are fastened onto the external wall portion of the building, the horizontal joint portions of the abutting building boards are not continuously connected to look straight-line, and are deviated in a vertical direction resulting in marring a designing feature of the external appearance of the construction.

### SUMMARY OF THE INVENTION

Accordingly, it is an object of the present invention to provide a printing apparatus and a printing method for a building board capable of obtaining an external appearance of a construction where both of horizontal joint portions at facing positions of abutting building boards look continuously straight-line, when constructed despite the case where the building board has a dimensional error.

According to an aspect of the present invention, a printing apparatus for printing a building board of a shiplap joint system, composed of a design surface having a horizontal joint portion formed along a longitudinal direction of the building board, and an upper and lower shiplap portions formed at an end portion of the building board, includes a fixed printing head having a plurality of nozzles for performing printing operation by means of emitting a jet of ink toward the design surface of the building board, in which the printing head performs printing operation along a printing line spaced apart from an edge of the upper shiplap portion or the lower shiplap portion at a constant distance when performing the printing operation for the horizontal joint portion.

According to the present invention, horizontal joint portions of the abutting building boards are continuously connected to look straight-line in external appearance without deviation when being fastened to and constructed on an external wall portion of a building even when the building board has a dimension error, and therefore a building board having a good external wall design without a sense of incongruity can be provided.

### BRIEF DESCRIPTION OF THE DRAWINGS

FIG. 1 is an illustration schematically showing a printing apparatus according to the present invention;

FIG. 2 is an explanatory view explaining positions of printing heads of the printing apparatus and a building board according to the present invention;

FIG. 3 is a top view showing a condition of three of the building boards having a width of a lower shiplap portion different from each other being conveyed in order, in the printing apparatus according to the present invention;

FIGS. 4A through 4C are illustrations partially showing a cross-sectional view of a construction of each of the building boards shown in FIG. 3 in an advancing direction;

FIG. 5 is an explanatory view explaining a method of printing a horizontal joint portion of the building board having widths of the lower shiplap portion that are different at the front and back in the printing apparatus according to the present invention;

FIG. 6 is an explanatory view explaining a schematic appearance of the building board of a shiplap joint system;

FIG. 7 is an explanatory view explaining a method of jointing the building boards by means of a four-direction shiplap joint system;

FIGS. 8A through 8C are explanatory views explaining a method for fastening the building board with a fastening member, and a deviation of the horizontal joint portions of the abutting building boards.

### DESCRIPTION OF THE PREFERRED EMBODIMENTS

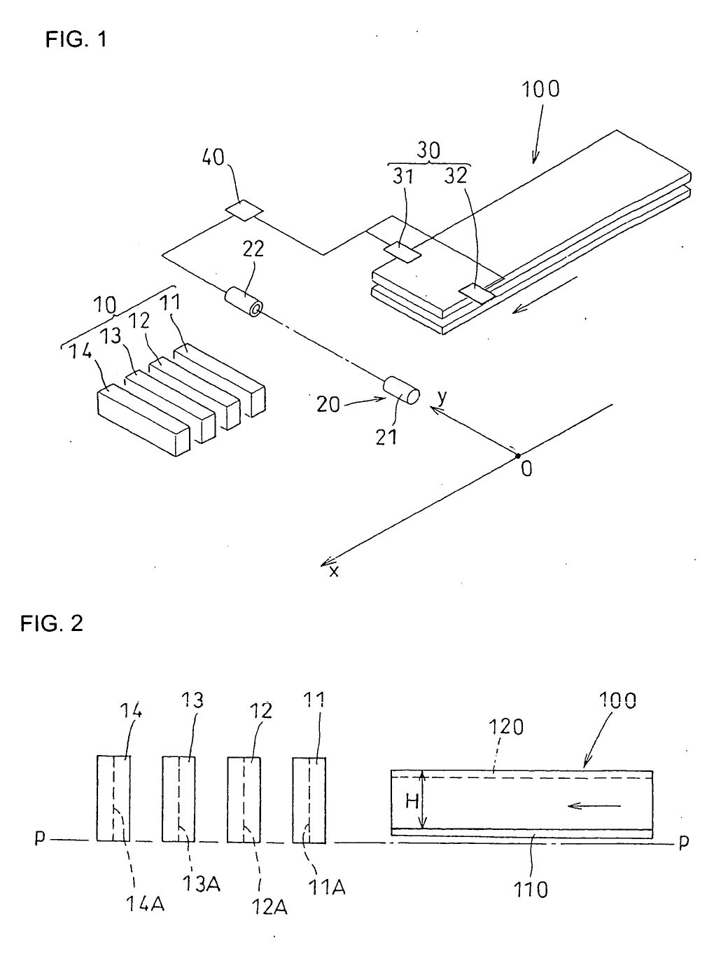

A printing apparatus according to the present invention will be schematically explained referring to FIG. 1. The printing apparatus of the present invention is provided with a printing head 10, a conveying apparatus (not shown) for moving an object to be printed, i.e., a building board (external wall board) 100, a position detecting device 20 for detecting whether the building board 100 has traveled through a predetermined position at an upstream side relative to the printing head 10, a measuring device 30 for measuring a printing width (width of the design surface in a direction of the shorter side) in a direction orthogonal to a longitudinal direction of the building board 100, an arithmetic unit 40 that creates printing control data while obtaining information from the position detecting device 20 and the measuring device 30, and transmits a printing control signal to the printing head 10. The printing apparatus of the present invention is a line-type printer where the printing head 10 is fixed, and a side of the building board 100 travels as shown in FIG. 1. The building board 100 is configured to travel while both end portions thereof in the longitudinal direction is guided by a guide (not shown) because the building board 100 is required to travel through a constant position in relation to the printing head 10.

As shown in FIG. 1, a moving direction of the building board 100 is defined as x-axis and a direction orthogonal thereto is defined as y-axis.

As shown in FIG. 2, the printing head 10 is composed of four printing heads, 11 of a color Y (yellow), 12 of a color M (magenta), 13 of a color C (cyan), and 14 of a color K (black), and these printing heads are arranged lining at a predetermined intervals along the moving direction of the building board 100. Each of the printing heads includes nozzle arrays, 11A, 12A, 13A, and 14A, arranged in a direction perpendicular to the moving direction of the building board 100.

When the building board 100 moves toward the printing head 10, a printing operation for the Y color is performed first, and then the printing operation for the M color is performed next, and further, the printing operations for the C color and for the K color are performed in order.

As shown in FIG. 2, a reference line p-p is set on the basis of the fixing position of the printing head 10 and the building board 10 is caused to travel while the side end portion of the building board 100 is guided. The guide (not shown) is provided at a position being in parallel with the reference line p-p.

The building board 100 is caused to travel while a side end portion of the lower shiplap portion 110 in a longitudinal direction of the building board 100 is in contact with the guide. This is because problems hardly occur even when the building board 100 is caused to travel at high speed being in contact with the guide in view of the fact that the lower shiplap portion 110 represents a non-design surface that is not seen from outside when the building board 100 is used for construction.

In contrast, the upper shiplap portion 120 in a longitudinal direction serves as a design surface that is seen from outside when the building board 100 is used for construction. Accordingly, for example, the building board 100 is caused to travel while contacting a rubber made roll guider. Thus, the building board 100 is caused to travel while guiding the both side end portions in the longitudinal direction thereof and therefore, the same can be caused to travel through the constant position without meandering.

The printing head 10 of the present invention is that of a line-type, and a dimension of each of the printing heads in a y-axis direction is greater than a printing width H of the building board 100. Accordingly, a surface of the building board 100 is printed by means of once passing the building board 100 under the printing head 10.

The position detecting device 20 may be constructed in a manner so as to include an optical signal transmitter 21 and an optical signal receiver 22 both provided at both sides of a moving path of the building board 100. The position detecting device 20 generates a leading edge detecting signal when detecting the leading edge of the building board 100 moving along a direction of x-axis, and generates a trailing edge detecting signal when detecting the trailing edge of the building board 100, and transmits both of the signals to the arithmetic unit 40.

The measuring device 30 is provided with a first and a second measuring device, 31 and 32, for measuring the printing width H of the building board 100, in a direction orthogonal to the longitudinal direction thereof at a sampling cycle. In concrete terms, both end positions of the printing width H are detected by means of the first and second measuring devices, 31 and 32, and a position of an edge portion of the upper shiplap portion 120 (end portion of a design in the design surface) is detected by means of the first measuring device 31 and a position of an end portion of the design in the design surface that is in contact with the lower shiplap portion 110 is detected by means of the second measuring device 32. Although a structure of the measuring device 30 is not explained in detail at this moment, for example, the dimension may be measured by means of image processing for an image obtained by a CCD imaging device or the like. Alternatively, the dimension may be measured by radiating light of each of the signals and receiving a reflected signal thereof.

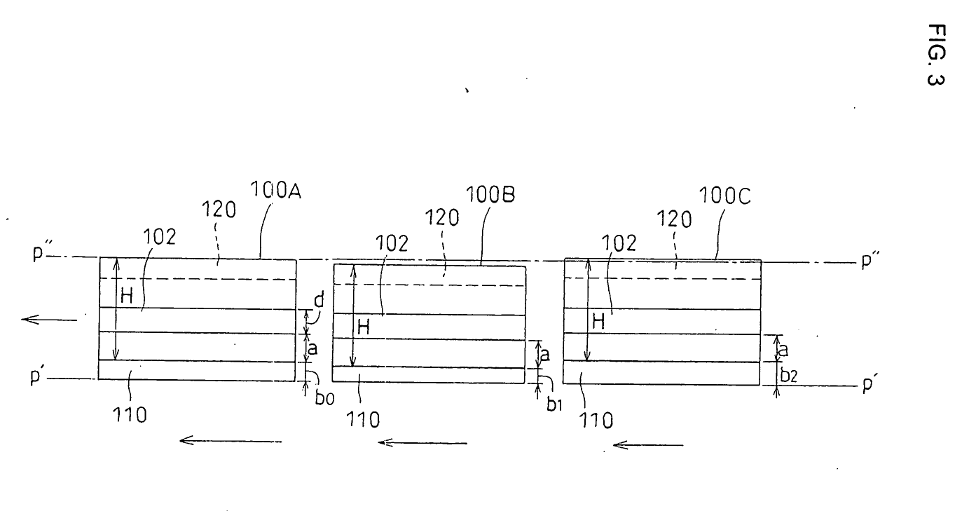

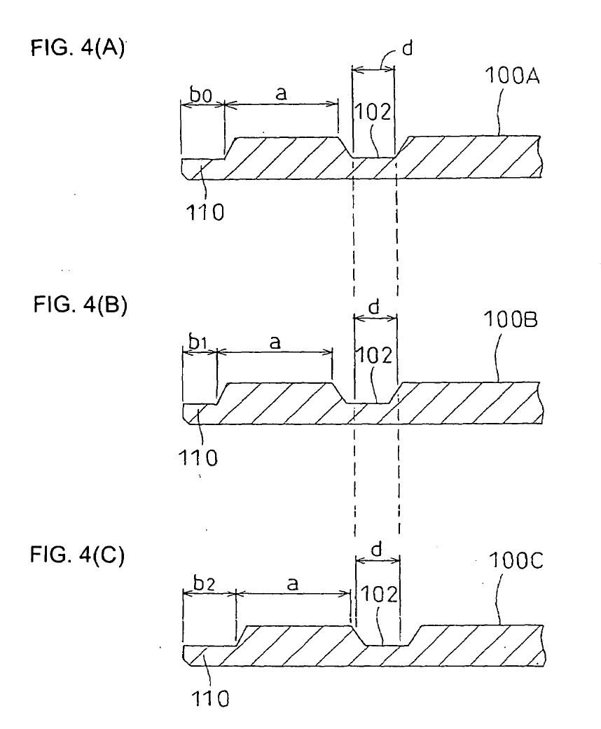

A printing method according to the present invention will be explained referring to FIGS. 3 and 4. FIG. 3 shows three building boards, 100A, 100B and 100C, advancing toward the printing head 10 (in a left direction on a paper surface). A line p′-p′ in FIG. 3 shows a guide line for the building board 100 that is in parallel with the reference line p-p described above. FIGS. 4A through 4C show a cross-sectional view of a construction of each of the building boards, 100A, 100B, and 100C, along a direction orthogonal to the moving direction thereof, in FIG. 3. In the building boards, 100A, 100B, and 100C, the width of the lower shiplap portion 110 is formed in approximately the same dimension of one and the same building board, as explained below. Further, it is assumed that there exist variations in the width only from one building board to the other, and that the printing width H is set to keep approximately a constant dimension about one building board throughout the entire length thereof. Furthermore, only one horizontal joint portion 102 (having a width dimension d) is shown as a representative of the horizontal joint portions 102 at the design surface of each of the building boards, 100A, 100B, and 100C, for convenience here.

As shown in FIG. 3, a distance from a lower end portion of the design surface (a borderline between the lower shiplap portion 110 and the design surface) to a lower end portion of the horizontal joint portion 102 is defined as “a”. Further, a dimension control area is set to ±1 mm, and a designing dimension of a width of the lower shiplap portion 110 of the building board 100A is defined as b₀ here, and the width of the lower shiplap portion 110 of the building board 100B is defined as b₁, which is shorter than b₀ by 1 mm, and the width of the lower shiplap portion 110 of the building board 100C is defined as b₂, which is longer than b₀ by 1 mm.

In the present embodiment, any one of the building boards, 100A, 100B, and 100C has approximately the same shape and the same dimension at the surface to be printed (the design surface), and the upper shiplap portion 120 can be equated with the design surface because the same is formed in the surface to be printed. Accordingly, a width of the lower shiplap portion 110 is mainly assumed to have a variation caused by a cutting error. Further, the building board 100 is caused to travel toward the printing head 10 along the guide line p′-p′ while the side end portion of the lower shiplap portion 110 is guided.

In a case that a processing configuration as described above is taken, although the same printed images are formed on the design surfaces of each of the building boards when the printing operation for the design surface is performed on the basis of the border line between the design surface detected by means of detecting the printing width H and the lower shiplap portion 110, the building board is sometimes abutted by a building board having a variation in the width of the lower shiplap portion 110 in a case that the thus printed building board is used for construction. As a result, a problem occurs in which the horizontal joint lines formed at both of the building boards are deviated in vertical directions in the external appearance and continuity in a horizontal direction cannot be secured.

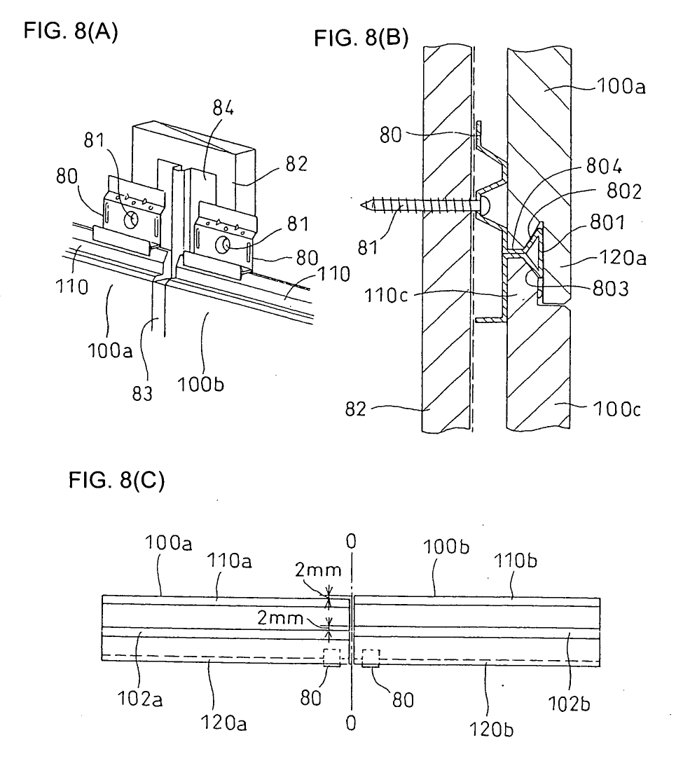

This is because, in the construction of the building boards for the external wall, as shown in FIG. 8B, the arranging position of the building board 100a being disposed at an upper side depends on a fixing position of the fastening member 80 since the fastening member 80 is engaged at an upper end edge of the lower shiplap portion 110c formed at an upper edge portion of the building board 100c arranged at a lower side, and screw fixed. In addition, since the width of the lower shiplap portion 110 has a variation, the horizontal joint line of both the building boards is deviated in the external appearance when the building boards having variety in width in the vertical direction (direction of the shorter side) different from each other are abuttingly arranged.

Accordingly, in the printing method according to the present invention, a process for shifting a printing area in the direction of the shorter side is performed for each of the building boards whose travel position is decided by the guide line p′-p′ shown in FIG. 3.

At this point, a horizontal control line p″-p″ where an edge portion of the upper shiplap portion 120 is positioned on the basis of the building board 100A is set. Further, the area of the printing width H of the building board 100B is shifted up until an upper end edge thereof comes in alignment with the horizontal control line p″-p″ that is located at an upper part of FIG. 3. On the contrary, the area of the printing width H of the building board 100C is shifted down until an upper end edge thereof comes in alignment with the horizontal control line p″-p″. Resulting from the process described above, the portions to be printed as the horizontal joint portion 102 of both of the building boards, 100B and 100C are positioned at the same level, and a selected ink-jet nozzle used for printing the horizontal joint portion 102 of the building board 100A is used without changing a position thereof. A shifting amount is found by means of the arithmetic unit 40 on the based of positional information obtained from the above-described measuring device 30.

On the other hand, although the horizontal joint portion is thus printed, the building board is caused to travel along the guide line p′-p′ while the side end portion of each of the lower shiplap portions 110 is being in contact with the guide. Accordingly, a deviation occurs between an actual printed result of the image for the horizontal joint portion 102 in each of the building boards, 100B and 100C, and the horizontal joint portion 102. Each of the deviations mentioned above is concretely shown in FIGS. 4A through 4C. In other words, an area indicated by a mark d in FIGS. 4A through 4C corresponds to a horizontal joint portion printing area.

In a condition of a construction of the thus printed building board, the horizontal joint portions 102 of the respective building boards, 100B and 100C, are not printed at positions indicated by the reference numerals 102 in FIG. 3, and a horizontal joint line is formed and printed on the basis of the upper shiplap portion 120 formed at a lower end portion of each of the building boards, 100B and 100C, such that a distance from a position of the lower end portion of the upper shiplap portion 120 to the horizontal joint line is equal to that from the position of the lower end portion of the upper shiplap portion 120 to the horizontal joint portion 102 to be a standard position. Therefore, the continuity of the horizontal line in the left and right building boards in the external appearance is secured, and the occurrence of the deviation is avoided resulting in large improvement of the designing characteristic of the external appearance of the external wall.

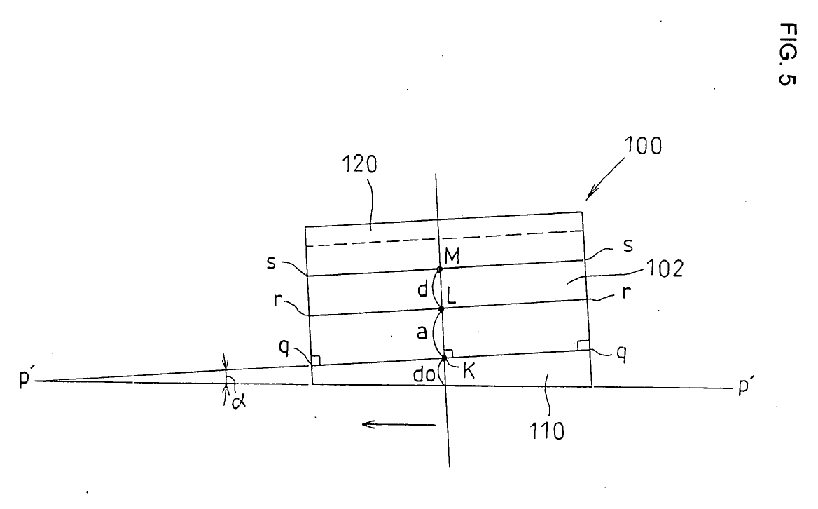

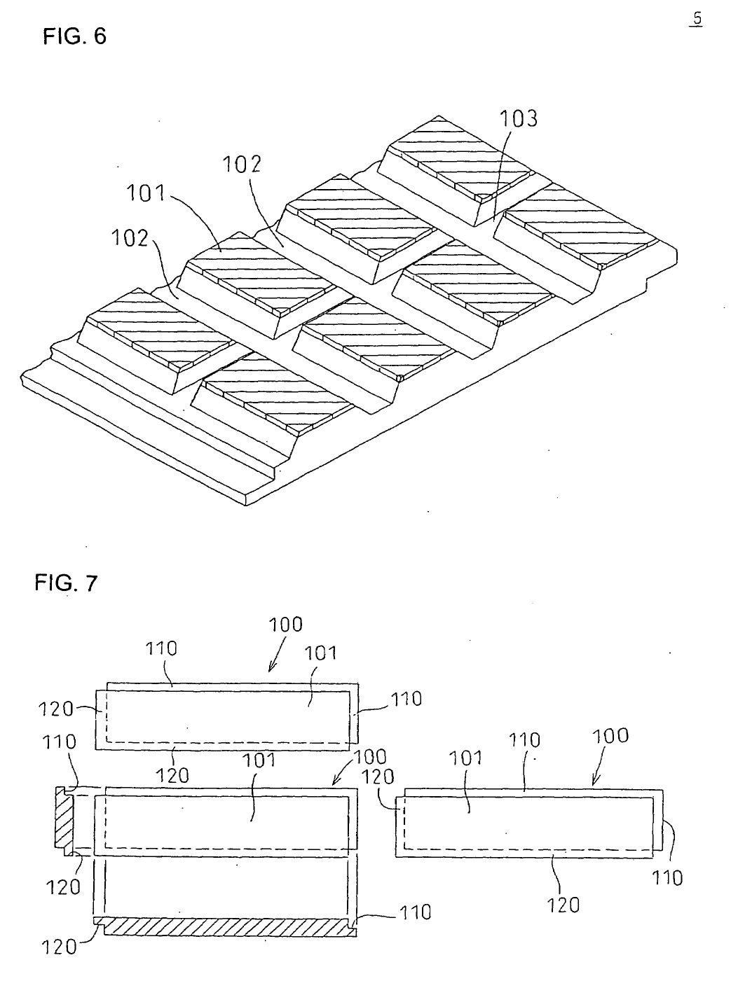

Next, a printing method, in which a width of the lower shiplap portion 110 is not constant in one building board, will be explained referring to FIG. 5. Although a variation of the width of the lower shiplap portion 110 is exaggeratedly illustrated in FIG. 5, the dimension variation is within an area that can be constructed in practice. As shown in FIG. 5, two of the opposing shorter sides of the building board 100 are approximately in parallel to each other, and two of the opposing longer sides are also in parallel to each other.

First, a boarder line q-q between the design surface and the lower shiplap portion 110 is found by means of the second measuring device 32. Next, a point K of a position, where the width of the lower shiplap portion 110 on the border line q-q is equal to a designed width d₀, is found. Further, a point L of a position that is distant from the point K by a designed distance “a” in which the designed distance “a” is a distance between the point K and the horizontal joint portion 102 is found. Furthermore, a point M of an upper side edge of the horizontal joint portion 102 that is distant form the point L by a designed distance d of the horizontal joint portion 102 is found. Thereafter, lines, r-r and s-s, that respectively pass through the points, L and M, which are in parallel with the border line q-q are found. The printing operation is performed while setting an area that is sandwiched between the parallel lines, r-r and s-s, obtained above to be a horizontal joint printing line. In this case, the printing operation for the horizontal joint printing line is performed upon converting processed printing data in which the printing data for the design surface is rotated in an extent of an angle α formed between the border line q-q and the guide line p′-p′ into printing control data for the nozzle to be used.

Although the embodiment of the present invention is explained above, the description is illustrative of the invention and it will be apparent to those skilled in the art that the invention is not limited to the embodiment disclosed, but is capable of numerous modifications within the scope of the invention as set forth in the claims.

What is claimed is:

1. A printing apparatus for printing a building board of a shiplap joint system composed of a design surface having a horizontal joint portion formed along a longitudinal direction of the building board, and an upper and lower shiplap portions formed at an end portion of the building board, comprising:
a fixed printing head having a plurality of nozzles for performing printing operation by means of emitting a jet of ink toward the design surface of the building board,
wherein the printing head performs printing operation along a printing line spaced apart from an edge of the upper shiplap portion or the lower shiplap portion at a constant distance when performing the printing operation for the horizontal joint portion.

2. The printing apparatus according to claim 1, wherein the printing line is identical of a printing line in a case of printing the horizontal joint portion of the building board having a standard dimension.

3. The printing apparatus according to claim 1, wherein the printing apparatus further comprises a dimension measuring device for measuring a position of an edge of the lower or upper shiplap portion of the building board and a distance from the edge to the horizontal joint portion, and wherein the printing head performs the printing operation along the printing line set on the basis of the distance from the edge to the horizontal joint portion measured by means of the measuring device when performing the printing operation for the horizontal joint portion.

4. A method for printing the building board of a shiplap joint system composed of a design surface having a horizontal joint portion formed along a longitudinal direction of the building board, and an upper and lower shiplap portions formed at an end portion of the building board, comprising the steps of:
measuring a position of an edge of a lower shiplap portion of the building board;
setting a printing line at a predetermined position from the measured position of the edge of the lower shiplap portion; and
printing the horizontal joint portion of the building board along the printing line.

5. A program capable of being read by means of a computer for performing the method according to claim 4 for printing the building board.
